(19) United States
(12) Patent Application Publication
(10) Pub. No.: US 2010/0284080 A1
(43) Pub. Date: Nov. 11, 2010

(54) RETROREFLECTIVE STRUCTURE WITH FABRIC FACE

(75) Inventor: Patrick W. Mullen, Barkhamsted, CT (US)

Correspondence Address: NIXON PEABODY LLP - PATENT GROUP, 1100 CLINTON SQUARE, ROCHESTER, NY, 14604, US

(73) Assignee: REFLEXITE CORPORATION, Avon, CT (US)

(21) Appl. No.: 12/678,224

(22) PCT Filed: Sep. 23, 2008
(86) PCT No.: PCT/US08/11014

§ 371 Date: May 27, 2010

Related U.S. Application Data
(60) Provisional application No. 60/995,098, filed on Sep. 24, 2007.

(51) Int. Cl. G02B 5/124; B05D 5/06

(52) U.S. Cl. 359/530; 427/163.4

(57) ABSTRACT

A fabric-backed retroreflective article has improved visual appearance by combining the fabric and retroreflective layers. An article, comprises a retroreflective layer formed of a resin that partially interpenetrates a fabric layer. Manufacturing a retroreflective article includes a retroreflective layer partially interpenetrating a fabric layer. The method includes disposing a layer of curable resin on a fabric layer; causing the layer of curable resin to partially penetrate the fabric layer; and curing the layer of curable resin, thereby forming the retroreflective layer partially interpenetrating the fabric layer.

### RELATED APPLICATION

This application claims the benefit of U.S. Provisional Application No. 60/995,098, filed on Sep. 24, 2007. The entire teachings of the above application is incorporated herein by reference.

### BACKGROUND OF THE INVENTION

Certain types of retroreflective products have glossy plastic or grey glassy surfaces that can be objectionable to some wearers. Attachment of a layer of fabric to such retroreflective films is one method of improving their visual appearance. Retroreflective articles that include fabric layers typically employ multilayer (laminate) structures in which a layer of fabric is attached to the back of retroreflective structure by an adhesive or a thermoplastic resin. One such product is described in U.S. Pat. No. 6,764,744. This results in a thick, poorly bendable structure that also tends to delaminate with wear or laundering.

### SUMMARY OF THE INVENTION

The present invention is a fabric-backed retroreflective article with improved visual appearance by combining the fabric and retroreflective layers in a novel and advantageous way.

In one embodiment, the present invention is an article, comprising a retroreflective layer formed of a resin or other curable polymer that partially interpenetrates a fabric layer.

In another embodiment, the present invention is a method of manufacturing a retroreflective article that includes a retroreflective layer partially interpenetrating a fabric layer. The method comprises the steps of disposing a layer of curable resin on a fabric layer; causing the layer of curable resin to partially penetrate the fabric layer; and curing the layer of curable resin, thereby forming the retroreflective layer partially interpenetrating the fabric layer.

The retroreflective articles of the present invention advantageously retain a fabric appearance, while providing for a thinner and more durable structure than those previously described. The process for manufacturing the retroreflective articles of the present invention is simple and comprises a reduced number of steps.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a schematic drawing of a retroreflective article of the present invention.

FIG. 2 is a schematic diagram showing the sequence of steps of one embodiment of the method of the present invention.

FIG. 3 is a schematic diagram showing the sequence of steps of an alternative embodiment of the method of the present invention.

### DETAILED DESCRIPTION OF A PREFERRED EMBODIMENT

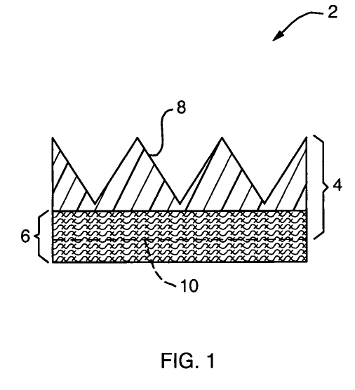

FIG. 1 illustrates a retroreflective article 2, which, according to one embodiment of the present invention, comprises a retroreflective layer 4 partially interpenetrating a fabric layer 6. The retroreflective layer has a facet side 8 and a base side 10, wherein the fabric layer 6 is disposed on the base side 10 of the retroreflective layer 4.

Preferably, the depth of interpenetration of the fabric layer 6 into the retroreflective layer 4 can be from about 20% of the thickness of the retroreflective layer 4 to about 80% of the thickness of the retroreflective layer 4.

The facet side 8 of the retroreflective layer 4 can include cube-corner prisms. The prisms can be either of the cube corner pyramidal type (i.e. having triangular faces), as shown in FIG. 1, or of the full cube type (i.e. having square, rectangular or hexagonal faces, not shown in FIG. 1).

Preferably, the retroreflective layer 4 is made from a thermo- or photocurable polymer. For example, the retroreflective layer 4 can comprise polyacrylate, epoxy acrylate, polyurethane, polyester acrylate or a silicone resin. Fabric layer 6 can be made from any fabric, woven or non-woven, that can withstand the process of curing the polymer from which retroreflective layer 4 is made. Preferably, the fabric is polyester, cotton fiberglass or nylon. Examples of suitable nylon fabrics are available from DAF Products, Inc. of Wycoff, N.J. Other suitable mesh fabrics are available from Seattle Fabrics, Seattle Wash.

In other embodiments, the examples of materials suitable for fabric layer 6 include clear nylon fabric or other transparent or semi-transparent materials. It is possible to control the degree of retroreflection by choosing open-weave fabrics for higher retroreflection, or closed weave fabrics for lower retroreflection.

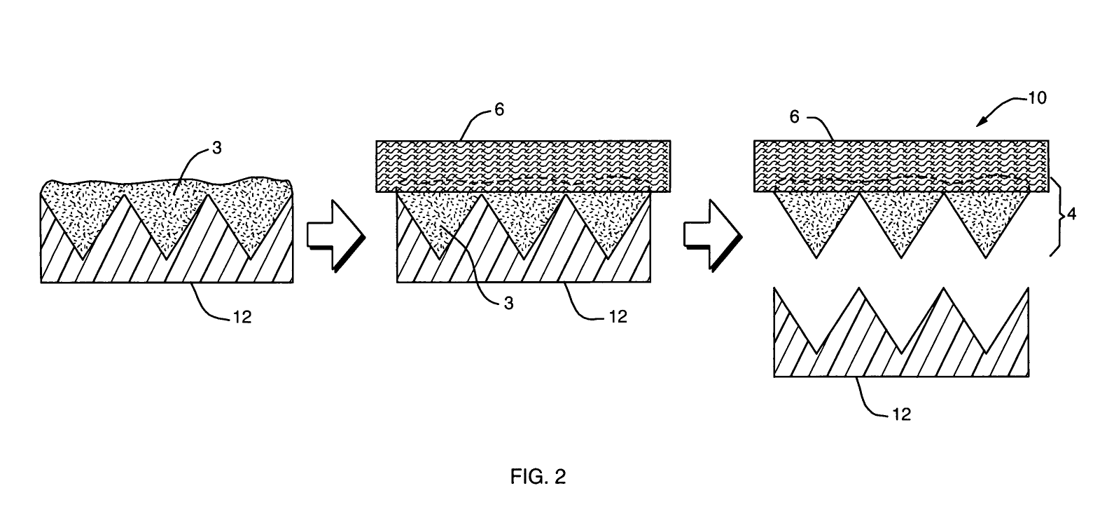

In one embodiment, the present invention is a method of manufacturing a retroreflective article that includes a retroreflective layer partially interpenetrating a fabric layer. FIG. 2 is a schematic diagram that illustrates one such embodiment. The method can comprise the following steps: (1) disposing a layer of curable resin 3 on microstructured tool 12 or on fabric layer 6; (2) bringing tool 12, curable resin 3 and fabric layer 3 into contact and causing the layer of curable resin 3 to partially penetrate the fabric layer 6; and (3) curing the layer of curable resin 3, thereby forming the retroreflective article 10 having the retroreflective layer 4 partially interpenetrating the fabric layer 6. As FIG. 2 depicts, application of the curable resin layer 3 onto the fabric layer 6 can be accomplished using a microstructured tool (mould) 12. In this embodiment, mould 12 is filled with a slight excess of curable resin and fabric layer 6 is then partially embedded in the uncured resin of layer 3. The fabric layer 6 is pressed onto the mould 12 prior to or during the resin curing process. After resin layer 3 is cured, article 10 is removed from mould 12.

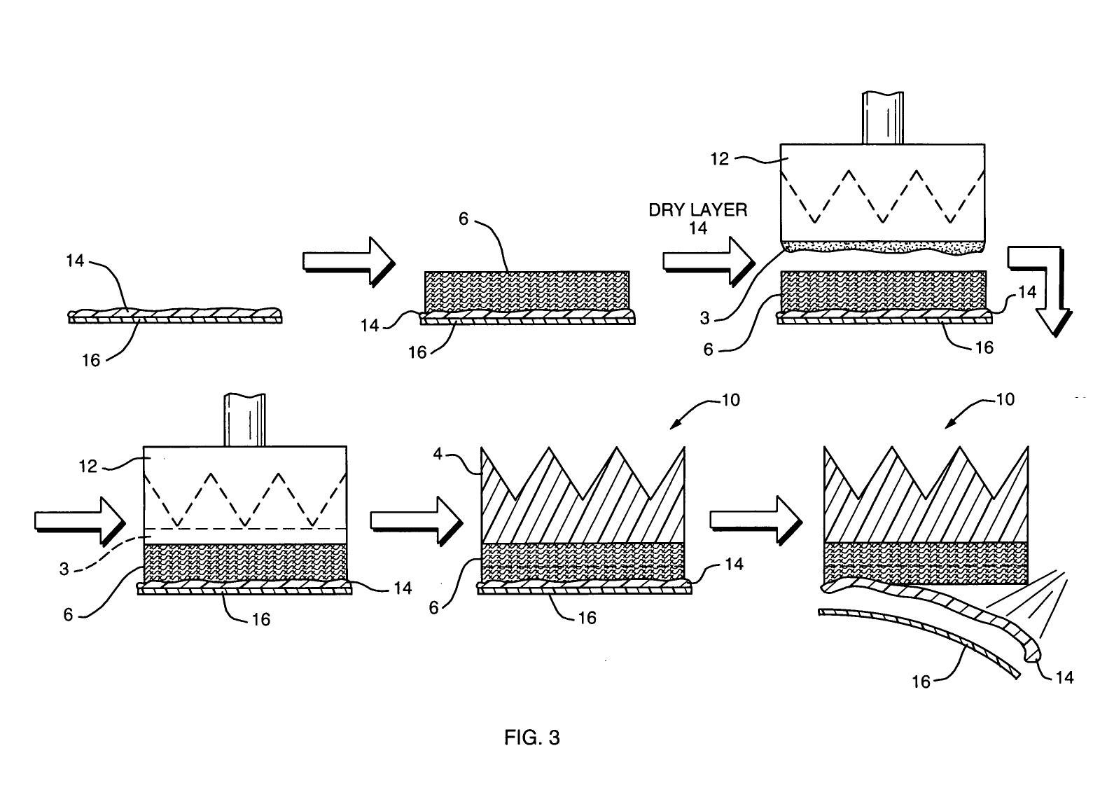

FIG. 3 is a schematic diagram that illustrates an alternative embodiment of the method of the present invention. In this embodiment, the manufacturing process begins by disposing a removable coating 14 on a carrier film 16. The removable coating 14 can be any water-soluble polymeric material. Examples of suitable water-soluble polymeric materials include polyvinyl alcohol and polyvinyl acetate. The carrier film 16 can be made from any sufficiently inert material that can withstand the manufacturing process. Examples of suitable materials include paper, polyethylene, metal, nylon and polyester. Nylon and polyester are preferred.

In the next step of this process, the fabric layer 6 is disposed on removable coating 14, prior to drying removable coating 14, so that removable coating 14 partially penetrates fabric layer 6, thereby attaching the fabric layer 6 to the carrier film 16.

Following the disposition of fabric layer 6, removable coating 14 is dried. Next, the microstructured tool (mould) 12, filled with the curable resin 3, is applied onto the exposed side of the fabric layer 6. This step is followed by pressing fabric layer 6 onto the mould 12 while the layer of the curable resin 3 is cured, thus forming the retroreflective layer 4.

As a result of the above-described steps, retroreflective article 10, comprising the retroreflective layer 4 partially interpenetrating fabric layer 6 is now attached to carrier film 16 by the removable coating 14. Next, carrier film 16 is stripped off and removable coating 14 is then removed by, for example, washing.

The tools and moulds that can be used for manufacturing the retroreflective articles described herein, for example tool 12 in FIG. 2 and FIG. 3, can, in some embodiments, be made from polymers. Alternatively, such tools can be made from metals. Tools made from polymers can be manufactured either by embossing the cube-corner forms onto the surface of preformed polymeric material, or by forming the desired mold by curing a polymeric resin. Similarly, a metal mold can be fabricated directly from a suitable metal by engraving, hobbing or by other suitable means of placing a desired cube-corner forms onto a tool surface. Alternative, a molten metal can be cast into a desired mold shape. Suitable methods of making molds are disclosed, for example, in U.S. Pat. Nos. 3,684,348 and 5,512,219, the entire teachings of which are incorporated herein by reference.

For example, in some embodiments, tool 12 can be made from nickel. Alternatively, tool 12 can be made from polycarbonates or a UV-cured polymer such as acrylate.

While this invention has been particularly shown and described with references to example embodiments thereof, it will be understood by those skilled in the art that various changes in form and details may be made therein without departing from the scope of the invention encompassed by the appended claims.

What is claimed is:

1. A method of manufacturing a retroreflective article that includes a retroreflective layer partially interpenetrating a fabric layer, said method comprising the steps of:
disposing a layer of curable resin on a fabric layer;
causing the layer of curable resin to partially penetrate the fabric layer; and
curing the layer of curable resin, thereby forming the retroreflective layer partially interpenetrating the fabric layer.

2. The method of claim 1, further including:
disposing a removable coating on a carrier film; and
causing removable coating to partially penetrate the fabric layer, thereby attaching the fabric layer to the carrier film.

3. The method of claim 3, further including:
following the formation of the retroreflective layer partially interpenetrating the fabric layer, removing the carrier film; and
removing the removable coating from the fabric layer.

4. The method of claim 1, wherein the retroreflective layer includes cube-corner prisms.

5. The method of claim 1, wherein the fabric layer comprises polyester, cotton fiberglass or nylon.

6. The method of claim 1, wherein the retroreflective layer comprises polyacrylate, epoxy acrylate, polyurethane, polyester acrylate or a silicone resin.

7. The method of claim 2, wherein the removable coating is a water-soluble polymer.

8. The method of claim 7, wherein the water-soluble polymer is polyvinyl alcohol or polyvinyl acetate.

9. The method of claim 2, wherein the carrier film comprises a material selected from the group consisting of paper, polyethylene and metal.

10. Claim 1, wherein the resin is cured in contact with a microstructured tool.

11. A retroreflective article, comprising:
a retroreflective layer partially interpenetrating a fabric layer.

12. The retroreflective article of claim 11, wherein the retroreflective layer has a facet side and a base side, and wherein the fabric layer is disposed on the base side of the retroreflective layer.

13. The retroreflective article of claim 11, wherein the retroreflective layer includes cube-corner prisms.

14. The retroreflective article of claim 11, wherein the fabric layer comprises polyester, cotton fiberglass or nylon.

15. The retroreflective article of claim 11, wherein the retroreflective layer comprises polyacrylate, epoxy acrylate, polyurethane, polyester acrylate or a silicone resin.
